(19) United States
(12) Patent Application Publication
(10) Pub. No.: US 2024/0327958 A1
(43) Pub. Date: Oct. 3, 2024

(54) Nb-ELEMENT MICRO-ALLOYED BULK MULTI-COMPONENT ALLOY WITH HIGH-TEMPERATURE RESISTANCE AND WEAR RESISTANCE, PREPARATION METHOD THEREFOR, AND APPLICATIONS THEREOF

(71) Applicants: WUHAN UNIVERSITY OF SCIENCE AND TECHNOLOGY, Wuhan (CN); BAND (FOSHAN) METALLIC COMPOSITE MATERIALS CO, LTD., Foshan (CN); SINO-ENERGY HUAYUAN FLOATING WIND INSTITUTE, Qingdao (CN)

(72) Inventor: Kaiming WU, Wuhan (CN)

(73) Assignees: WUHAN UNIVERSITY OF SCIENCE AND TECHNOLOGY, Wuhan (CN); BAND (FOSHAN) METALLIC COMPOSITE MATERIALS CO., LTD., Foshan (CN); SINO-ENERGY HUAYUAN FLOATING WIND INSTITUTE, Qingdao (CN)

(21) Appl. No.: 18/619,233

(22) Filed: Mar. 28, 2024

(30) Foreign Application Priority Data
Mar. 29, 2023 (CN) 2023103245230

(51) Int. Cl. C22C 30/00; C22C 1/04

(52) U.S. Cl. CPC C22C 30/00; C22C 1/04

(57) ABSTRACT

A Nb-element micro-alloyed bulk multi-component alloy with high-temperature resistance and wear resistance, a preparation method therefor, and applications thereof are provided. The alloy includes chemical components at corresponding contents: 2.10-2.24 wt % of Al, 20.70-20.86 wt % of Cr, 35.20-35.54 wt % of Ni, 19.10-19.46 wt % of Ti, 0.70-0.85 wt % of Nb, and the balance of Fe and unavoidable impurities, and the chemical components need to simultaneously meet relations: (1) 24.76≤Fe/Nb≤31.72; (2) 6.81≤Fe/(Nb+Al)≤7.93; (3) 1.04≤Fe/(Nb+Ti)≤1.13. Wear resistance of the alloy is 4-5 times higher than that of a traditional wear-resistant material NM500 in terms of the same hardness. After two-step tempering heat treatment under the same parameters, the NM500 is reduced in hardness by 58.64-68.93% with respect to its quenched and tempered condition, and the hardness of material of this invention is reduced by 31.75-37.74% with respect to its as-cast condition.

### CROSS REFERENCE TO THE RELATED APPLICATIONS

This application is based upon and claims priority to Chinese Patent Application No. 202310324523.0, filed on Mar. 29, 2023, the entire contents of which are incorporated herein by reference.

### TECHNICAL FIELD

The present invention belongs to the field of technologies for designing and preparing novel alloy materials, and in particular, relates to a Nb-element micro-alloyed bulk multi-component alloy with high-temperature resistance and wear resistance, a preparation method therefor, and applications thereof.

### BACKGROUND

Multi-principal element or multi-component alloy materials, first proposed by Professor Ye Junwei in 2004, are a class of novel alloy materials consisting of five or more metal elements at an equal molar ratio or a nearly equal molar ratio. They break with the design concept of traditional alloys taking one element as the principal element, demonstrate excellent performances and unprecedented application prospects, and have become a research hotspot in the field of materials recently. Under the four special effects of multi-component alloys, they demonstrate outstanding academic research values and industrial development potentials, providing a new idea for the field of wear-resistant materials.

A patented technology “PREPARATION METHOD FOR AlCoCrFeNi SERIES DOUBLE-PHASE STRUCTURE MULTI-COMPONENT ALLOY” (CN113025865A) describes a multi-component alloy ingot including the following elements in percentage by mass: 20.91-22.31 wt % of Co, 18.45-19.68 wt % of Cr, 19.82-21.14 wt % of Fe, 26.66-31.24 wt % of Ni, and the balance of Al, with the sum of the atomic percentages of all components being 100%. The multi-component alloy ingot is prepared by a vacuum arc smelting method and then machined into a cast rod. A cast rod of the multi-component alloy has a yield strength of 960 MPa, a breaking strength of 1270 MPa, and a percentage elongation of 1.3%. Although the multi-component alloy is significantly improved in strength and toughness by this technology, its percentage elongation is obviously lower than that of a general multi-component alloy, and its hardness and wear resistance have greater room for improvement.

A patented technology “SUPERHARD WEAR-RESISTANT MULTI-COMPONENT ALLOY AND PREPARATION METHOD THEREFOR” (CN112831710A) describes a multi-component alloy ingot including the following components in percentage by mass: basic components including Ta, Nb, W and Mo, and strengthening components including Fe, Co and Cr, wherein the basic components are combined with one or two types of strengthening components for proportioning at an equal molar ratio. The multi-component alloy ingot is prepared by a vacuum are smelting method, and has the hardness of 1000-1200 HV, and the wear resistance 4-5 times higher than that of traditional steel. Although this technology has significantly improved the hardness and wear resistance of the multi-component alloy, the metal elements used are expensive and are not suitable for large-scale industrial production.

An existing study on wear resistance of AlCrFeNiTi series multi-component alloys (Ming-Hao Chuang, Ming-Hung Tsai, Woei-Ren Wang, Su-Jien Lin, Jien-Wei Yeh, Microstructure and wear behavior of AlxCo1.5CrFeNi1.5Tiy high-entropy alloys, Acta Materialia. Volume 59, Issue 16, 2011, Pages 6308-6317, ISSN 1359-6454, https://doi.org/10.1016/j.actamat.2011.06.041.) improves the wear resistance of alloys by changing molar ratios of Al and Ti elements, whereby a four-component multi-component alloy with the hardness of 450-720 HV achieves the wear resistance 2-4 times higher than that of bearing steel and high-speed steel of the same hardness, showing certain limitations for the improvement of the hardness and wear resistance of multi-component alloys.

A wide variety of alloys are now available and can meet the actual production needs, but their service conditions at too high temperature have a very adverse impact on the alloys. For example, when the temperature reaches 600° C. most steel is greatly reduced in yield strength with respect to its as-cast condition, and is adversely affected in its plasticity and toughness at the same time. As a result, the hardness and wear resistance of the final alloy are affected. A bulk high-entropy alloy with trace amounts of Nb element and high wear resistance provided by the present invention has both the high hardness characteristic and the stability under high temperature conditions, and under high temperature service conditions, its hardness has no significant change similar to that of NM500. In addition, in occasions with actual wear, the Nb element in an alloy system of the present invention has a protective effect on an oxide film formed on the surface of the alloy, protecting an alloy matrix from further oxidation and wear, such that the alloy has the advantage of maintaining high hardness and wear resistance in a hot environment.

There are several main methods for achieving high-temperature strength, including: (1) microalloying using Mo, Nb, V and the like to improve high-temperature resistance; (2) alloying using expensive Ni, Cr and Mo to improve high-temperature resistance; and (3) conducting structure control on austenite and ferrite, which are stable in high-temperature performance, to improve high-temperature resistance. The above methods have high alloy cost and complex manufacturing processes or structure control methods, leading to increased manufacturing cost.

The present invention obtains a multi-component alloy material with high hardness, high wear resistance and excellent high-temperature resistance by reasonably controlling the ratios of various high-entropy alloying elements and the content of Nb element, and the multi-component alloy material has low cost and simple process and demonstrates better high-temperature stability.

### SUMMARY

In order to address the shortcomings of the prior art, the present invention provides a Nb-element micro-alloyed bulk multi-component high-entropy alloy with high-temperature resistance and wear resistance, a preparation method therefor, and applications thereof.

The technical solution provided by the present invention is as follows:
a Nb-element micro-alloyed bulk multi-component alloy with high-temperature resistance and wear resistance includes the following chemical components at corresponding contents in percentage by mass: 2.10-2.24 wt % of Al, 20.70-20.86 wt % of Cr, 35.20-35.54 wt % of Ni. 19.10-19.46 wt % of Ti, 0.70-0.85 wt % of Nb, and the balance of Fe and unavoidable impurities, and the chemical components need to simultaneously meet the following three relations expressed in percentage by mass: (1) 24.76≤Fe/Nb≤31.72; (2) 6.81≤Fe/(Nb+Al)≤7.93; (3) 1.04≤Fe/(Nb+Ti)≤1.13.

The Nb-element micro-alloyed bulk multi-component alloy with high-temperature resistance and wear resistance provided by the technical solution described above has a uniformly distributed structure, high hardness, and good wear resistance which is 4-5 times higher than that of a traditional wear-resistant material NM500 in terms of the same hardness.

The present invention further provides a preparation method for the Nb-element micro-alloyed bulk multi-component alloy with high-temperature resistance and wear resistance described above. The preparation method includes the following steps: proportioning according to the chemical components and contents of the Nb-element micro-alloyed bulk multi-component alloy with high-temperature resistance and wear resistance, smelting with a vacuum arc smelting furnace, and casting with a copper mold process to obtain an ingot blank, which is a cast-molded material that can be used directly, and which is the Nb-element micro-alloyed bulk multi-component alloy with high-temperature resistance and wear resistance.

Specifically, with elemental particles of aluminum, chromium, iron, nickel, titanium, and niobium with a purity of 99.99% as raw materials, the raw materials are sanded on surfaces with sandpaper to remove surface oxides, ultrasonically cleaned in water and alcohol sequentially, and dried at the temperature of 50-80° C. for 0.5-2 h for later use.

Specifically, the pretreated small metal particles are weighed according to the usage amounts of the respective elements for proportioning; and the proportioned raw materials are placed and smelted by arranging high-melting-point elements below low-melting-point elements.

Specifically, during metal smelting, smelting parameters are set to the following values: a vacuum degree of 1.5-2.5×10⁻³ Pa, a pressure of −0.04 to −0.06 MPa after filling of an inert gas, and a smelting current of 250 A-700 A during smelting.

Specifically, the smelting is repeated 1-3 times with vacuum are furnace smelting and copper mold casting processes.

The present invention further provides an application of the Nb-element micro-alloyed bulk multi-component alloy with high-temperature resistance and wear resistance as described above in preparation of a cutting tool or mold with high wear resistance.

The present invention further provides another application of the Nb-element micro-alloyed bulk multi-component alloy with high-temperature resistance and wear resistance as described above in preparation of materials for remanufacturing of mechanical products.

In a performance test, the prepared as-cast multi-component alloy specimen is tempered as follows:
1) the specimen of the present invention and a comparison sample NM500 are placed in a QRX1700 box-type atmosphere furnace, heated to 500-700° C. and heat-preserved for 8-10 h, and then air-cooled at room temperature;
2) after the first heating and cooling, the specimen and the comparison sample NM500 are placed in the QRX1700 box-type atmosphere furnace again, heated to 900-1100° C. and heat-preserved for 8-10 h, and then air-cooled at room temperature; and
3) the hardness of the tempered alloy is measured and compared with that of NM500.

Due to the adoption of the above technical solution, the present invention has the following positive effects compared with the prior art:
1) the Nb-element micro-alloyed bulk multi-component alloy with high-temperature resistance and wear resistance as prepared by the present invention has a hardness value up to 800 HV, showing a significant improvement compared with the hardness value of 600 HV of a multi-component alloy system without the addition of Nb element;
2) the Nb-element micro-alloyed bulk multi-component alloy with high-temperature resistance and wear resistance as prepared by the present invention has better wear resistance, which is 3-4 times higher than that of the multi-component alloy system without the addition of Nb element;
3) arc smelting is used during the preparation of the alloy to prevent volatile loss, and the components of the prepared alloy have low burning loss, and are substantially the same as the configuration components;
4) the five elements, namely Al, Cr, Fe, Ni and Ti, have similar atomic radii, and the Nb-element is added thereto to form a six-membered system having a higher entropy value of mixing, which reduces the Gibbs free energy of the system, promotes the formation of a solid solution phase, inhibits the formation of a compound phase, and improves the stability of the multi-component alloy;
5) the atomic radius of Nb atom is 115% of the average atomic radius of other atoms, and by adding the trace amounts of Nb element, a large lattice distortion can be formed inside the alloy without affecting the stability of the alloy, thereby preventing dislocation slip, significantly improving the solid solution strengthening effect of the alloy, and manufacturing a multi-component alloy material with greater hardness and higher wear resistance;
6) the metal elements used in the present invention are cheap, which contributes to the industrial mass production; and
7) the properties of the following elements themselves have a positive effect on the improvement of the performances of the alloy.

Ti: Titanium is a high-melting-point element located in the middle transition region of the periodic table of elements, and thus is liable to form an interstitial solid solution structure with an alloy during its binding to the alloy, and the comprehensive mechanical properties of the alloy can be improved to a certain extent under the action of solid solution strengthening. In addition, titanium has the effect of refining the grain structure of the alloy to form a fine and dense structure, which has a positive effect on improving the strength and toughness of the alloy. In the process of wear, the titanium element is easily oxidized to form an oxide film, which plays a role in lubrication protection during friction, thereby achieving the effect of reducing the wear rate of the alloy.

Cr: Chromium is a major element resistant to high temperature oxidation in common alloy systems. Due to its own high melting point, it produces, during wear and heating, Cr₂O₃ or a chromium-containing spinel structure to constitute a dense and continuous oxide layer to block the further contact between a gas and an alloy matrix, thereby improving the high-temperature oxidation resistance of the material. In addition, chromium is a strong carbide-forming element, which can form a large number of carbides such as Cr₂₃C₆ to effectively improve the wear resistance of the alloy. The higher chromium content can enhance the hardenability of the alloy, such that the alloy is less liable to crack under an extreme working condition, such as a thermal shock environment, thereby prolonging the service life of the alloy. Since excessive chromium content results in increased production cost, the chromium content in the present invention is 20.70-20.86 wt %, which ensures good practicality, including excellent high temperature oxidation resistance and good wear resistance, for the prepared multi-component alloy in a working environment with alternating heating and cooling.

Ni: Nickel is a hard, ductile and ferromagnetic metalthat is highly polishable and corrosion-resistant. Nickel is a siderophile metal, which is liable to bind to an iron element in an alloy system to improve the hardness of the alloy. Nickel is insoluble in water, and in a humid air at room temperature, a dense oxide film is formed on the surface of nickel to prevent a base metal from further oxidization, and at the same time, to improve the wear resistance of the alloy surface.

Al: The aluminum element itself has an FCC structure, and simultaneously is an element for promoting the formation of a BCC phase in the multi-component alloy system, and adding an appropriate amount of aluminum element results in higher proportion of the BCC phase structure in the alloy system, thereby improving the overall strength, hardness, and wear resistance of the alloy. The aluminum element has an obvious regulatory effect on the properties of a double-phase multi-component alloy, and promotes the formation, inside the alloy, of a bidirectional structure with better performances than a unidirectional structure. Aluminum is a light metal element with an atomic radius of 0.143 nm, and adding Al can distort the original lattice structure and reduce the free energy of the system to achieve a solid solution strengthening effect. At the same time, aluminum can also form a dense oxide film on the surface of the alloy to improve the high-temperature oxidation resistance and wear resistance of the alloy.

Nb: The niobium element functions to refine grains or strengthen precipitation in traditional alloys, and also plays an important role in multi-component alloys. Nb has better oxidability than Co. Cr and Ni, and its eutectic structure reduces the inhomogeneity of local plastic deformation and delays the emergence of cracks on a worn surface, thereby improving the wear resistance of an alloy. The niobium element is often capable of improving the chemical stability of an oxide film on the surface of the alloy. Therefore, niobium can change a microstructure in an alloy by virtue of its characteristics such as higher melting point, negative mixing enthalpy and larger atomic radius. Consequently, the addition of niobium increases the lattice distortion of the alloy or allows the precipitation of a second phase in a matrix to enhance the solid solution strengthening and precipitation hardening effects, thereby improving the performances of the alloy.

In summary, the present invention obtains a multi-component alloy ingot with excellent hardness and wear resistance by reasonably controlling the ratios of various elements and the content of Nb element. The bulk multi-component alloy with a trace amount of Nb element and high wear resistance as prepared by the present invention is suitable for occasions such as mechanically reciprocating parts and cutting tools. The multi-component alloy has a uniformly distributed structure, high hardness, and good wear resistance which is 4-5 times higher than that of a traditional wear-resistant material NM500 in terms of the same hardness. After two-step tempering heat treatment under the same parameters, the NM500 is reduced in hardness by 58.64-68.93% with respect to its as-cast condition, and the hardness of the alloy of the present invention is reduced by 33.09-37.76% with respect to its as-cast condition, showing better high-temperature stability.

### BRIEF DESCRIPTION OF THE DRAWINGS

FIG. 1 is a 1000-fold SEM diagram of a highly wear-resistant bulk multi-component alloy containing a trace amount of Nb element as prepared in Embodiment 1 of the present invention;

FIG. 2 is a 1000-fold SEM diagram of a highly wear-resistant bulk multi-component alloy containing a trace amount of Nb element as prepared in Embodiment 2 of the present invention;

FIG. 3 is a 1000-fold SEM diagram of a highly wear-resistant bulk multi-component alloy containing a trace amount of Nb element as prepared in Embodiment 3 of the present invention; and

FIG. 4 is a 1000-fold SEM diagram of a multi-component alloy prepared in Comparative Example 1 of the present invention.

### DETAILED DESCRIPTION OF THE EMBODIMENTS

The principles and features of the present invention will be described below, and the examples given are intended to explain the present invention only and are not intended to limit the scope of the present invention.

### EMBODIMENT 1

Preparation of Highly Wear-Resistant Bulk Multi-Component Alloy Containing Trace Amount of Nb Element

The preparation method described in this embodiment was as follows.

With elemental particles of aluminum, chromium, iron, nickel, titanium, and niobium with a purity of 99.99% as raw materials, the raw materials were first sanded on surfaces with sandpaper to remove surface oxides, then ultrasonically cleaned in water and alcohol, and then dried at 80° C. for 2 h for later use. Proportioning was carried out in the following percentages by mass: 2.10 wt % of Al, 20.70 wt % of Cr, 35.20 wt % of Ni, 19.10 wt % of Ti, 0.70 wt % of Nb, and 22.2 wt % of Fe. High-temperature smelting was carried out by using a vacuum arc smelting furnace. Specifically, the elemental particles were first mixed and placed into a water-cooled copper crucible of the arc smelting furnace; the crucible was first vacuumized, and when a vacuum degree reached 2.0×10⁻³ Pa, an inert gas was filled to −0.05 MPa for alloy smelting, with an are striking current of 250 A and a smelting current of 350 A; after the end of smelting, rapid water cooling was carried out and then an ingot was turned over; and the smelting was repeated 3 times to obtain a superhard wear-resistant multi-component alloy ingot. After the end of smelting, a multi-component alloy material ingot was obtained in the water-cooled copper crucible.

The prepared specimen was subjected to a microhardness test experiment (a microhardness test using a HV-1000 Vickers hardness tester), and the hardness of the sample in Embodiment 1 of the present invention could reach 813 HV1.

The prepared specimen was subjected to a sliding friction wear test (Bruker, UMT3, USA wear test prototype), in which a stainless-steel material was selected as a grinding material, with a load of 30 N, the room temperature as a working temperature, and the wear time of 30 min. The alloy may be worn by means of rotation or reciprocating linear motion, with a rotation speed of 200 r/min, or a reciprocating motion speed of 0.1 m/s. A wear resistance index (wear mass) of the multi-component alloy material of the present invention was 2.3 times higher than the traditional wear-resistant steel NM500, and 4 times higher than a multi-component alloy material without the Nb element added.

The prepared multi-component alloy was tempered as follows: 1) the specimen of the present invention and a comparison sample NM500 were placed in a QRX1700 box-type atmosphere furnace, heated to 500° C. and heat-preserved for 8 h, and then air-cooled at room temperature; and 2) after the first heating and cooling, the specimen and the comparison sample NM500 were placed in the QRX1700 box-type atmosphere furnace again, heated to 900° C. and heat-preserved for 8 h, and then air-cooled at room temperature; and 3) the hardness of the tempered multi-component alloy of Embodiment 1 was measured to 506.14 HV1, and the hardness of NM500 tempered under the same conditions was 219.23 HV1.

According to the tempering test results, the hardness of the multi-component alloy prepared in this embodiment was reduced by 37.74%, the hardness of NM500 was reduced by 58.64%, and the hardness reduction ratio of the multi-component alloy was nearly 20% lower than that of NM500.

### EMBODIMENT 2

### Preparation of Highly Wear-Resistant Bulk Multi-Component Alloy Containing Trace Amount of Nb Element

The preparation method described in this embodiment was as follows.

With elemental particles of aluminum, chromium, iron, nickel, titanium, and niobium with a purity of 99.99% as raw materials, the raw materials were first sanded on surfaces with sandpaper to remove surface oxides, then ultrasonically cleaned in water and alcohol, and then dried at 80° C. for 2 h for later use. Proportioning was carried out in the following percentages by mass: 2.24 wt % of Al, 20.86 wt % of Cr, 35.54 wt % of Ni. 19.46 wt % of Ti, 0.85 wt % of Nb, and 21.05 wt % of Fe. High-temperature smelting was carried out by using a vacuum are smelting furnace. Specifically, the elemental particles were first mixed and placed into a water-cooled copper crucible of the arc smelting furnace; the crucible was first vacuumized, and when a vacuum degree reached 2.0×10⁻³ Pa, an inert gas was filled to −0.05 MPa for alloy smelting, with an arc striking current of 250 A and a smelting current of 350 A; after the end of smelting, rapid water cooling was carried out and then an ingot was turned over; and the smelting was repeated 3 times to obtain a superhard wear-resistant multi-component alloy ingot. After the end of smelting, a multi-component alloy material ingot was obtained in the water-cooled copper crucible.

The prepared specimen was subjected to a microhardness test experiment (a microhardness test using a HV-1000 Vickers hardness tester), and the hardness of the sample in Embodiment 2 of the present invention could reach 826 HV1.

The prepared specimen was subjected to a sliding friction wear test (Bruker, UMT3, USA wear test prototype), in which a stainless-steel material was selected as a grinding material, with a load of 30 N, the room temperature as a working temperature, and the wear time of 30 min. The alloy may be worn by means of rotation or reciprocating linear motion, with a rotation speed of 200 r/min. or a reciprocating motion speed of 0.1 m/s. A wear resistance index (wear mass) of the multi-component alloy material of the present invention was 2.5 times higher than the traditional wear-resistant steel NM500, and 4.4 times higher than the multi-component alloy material without the Nb element added.

The prepared multi-component alloy was tempered as follows: 1) the specimen of the present invention and a comparison sample NM500 were placed in a QRX1700 box-type atmosphere furnace, heated to 600° C. and heat-preserved for 9 h, and then air-cooled at room temperature; and 2) after the first heating and cooling, the specimen and the comparison sample NM500 were placed in the QRX1700 box-type atmosphere furnace again, heated to 1000° C. and heat-preserved for 9 h. and then air-cooled at room temperature; and 3) the hardness of the tempered multi-component alloy of Embodiment 2 was measured to 563.71 HV1, and the hardness of NM500 tempered under the same conditions was 201.29 HV1.

According to the tempering test results, the hardness of the multi-component alloy prepared in this embodiment was reduced by 31.75%, the hardness of NM500 was reduced by 62.02%, and the hardness reduction ratio of the multi-component alloy was nearly 30% lower than that of NM500.

### EMBODIMENT 3

### Preparation of Highly Wear-Resistant Bulk Multi-Component Alloy Containing Trace Amount of Nb Element

The preparation method described in this embodiment was as follows.

With elemental particles of aluminum, chromium, iron, nickel, titanium, and niobium with a purity of 99.99% as raw materials, the raw materials were first sanded on surfaces with sandpaper to remove surface oxides, then ultrasonically cleaned in water and alcohol, and then dried at 80° C. for 2 h for later use. Proportioning was carried out in the following percentages by mass: 2.17 wt % of Al, 20.78 wt % of Cr, 35.37 wt % of Ni, 19.28 wt % of Ti, 0.77 wt % of Nb, and 21.63 wt % of Fe.

High-temperature smelting was carried out by using a vacuum arc smelting furnace. Specifically, the elemental particles were first mixed and placed into a water-cooled copper crucible of the arc smelting furnace; the crucible was first vacuumized, and when a vacuum degree reached 2.0×10⁻³ Pa, an inert gas was filled to −0.05 MPa for alloy smelting, with an arc striking current of 250 A and a smelting current of 350 A; after the end of smelting, rapid water cooling was carried out and then an ingot was turned over; and the smelting was repeated 3 times to obtain a superhard wear-resistant multi-component alloy ingot. After the end of smelting, a multi-component alloy material ingot was obtained in the water-cooled copper crucible.

The prepared specimen was subjected to a microhardness test experiment (a microhardness test using a HV-1000 Vickers hardness tester), and the hardness of the sample in Embodiment 3 of the present invention could reach 820 HV1.

The prepared specimen was subjected to a sliding friction wear test (Bruker, UMT3, USA wear test prototype), in which a stainless-steel material was selected as a grinding material, with a load of 30 N, the room temperature as a working temperature, and the wear time of 30 min. The alloy may be worn by means of rotation or reciprocating linear motion, with a rotation speed of 200 r/min, or a reciprocating motion speed of 0.1 m/s. A wear resistance index (wear mass) of the multi-component alloy material of the present invention was 2.4 times higher than the traditional wear-resistant steel NM500, and 4.2 times higher than the multi-component alloy material without the Nb element added.

The prepared multi-component alloy was tempered as follows: 1) the specimen of the present invention and a comparison sample NM500 were placed in a QRX1700 box-type atmosphere furnace, heated to 700° C. and heat-preserved for 10 h, and then air-cooled at room temperature; and 2) after the first heating and cooling, the specimen and the comparison sample NM500 were placed in the QRX1700 box-type atmosphere furnace again, heated to 1100° C. and heat-preserved for 10 h. and then air-cooled at room temperature; and 3) the hardness of the tempered multi-component alloy of Embodiment 3 was measured to 557.56 HV1, and the hardness of NM500 tempered under the same conditions was 164.65 HV1.

According to the tempering test results, the hardness of the multi-component alloy prepared in this embodiment was reduced by 32.01%, the hardness of NM500 was reduced by 68.93%, and the hardness reduction ratio of the multi-component alloy was nearly 35% lower than that of NM500.

### COMPARATIVE EXAMPLE

Preparation of Multi-Component Alloy without Nb Element

The preparation method and test method are the same as those in Embodiments 1-3, except the difference only in the percentages by mass of respective component elements as follows: 2.17 wt % of Al, 20.78 wt % of Cr, 35.37 wt % of Ni, 19.28 wt % of Ti, 0 wt % of Nb, and 22.40 wt % of Fe. The hardness of the sample in the comparative example could reach 759 HV1, and all the performances were tested in the same perspective as the above embodiments.

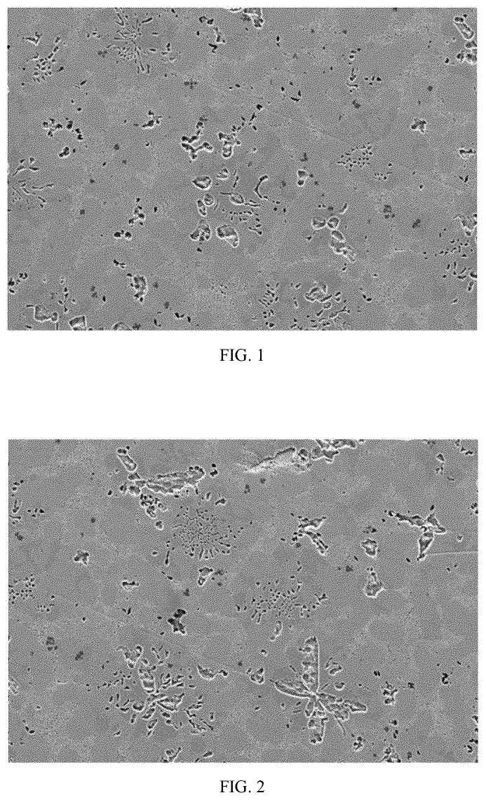

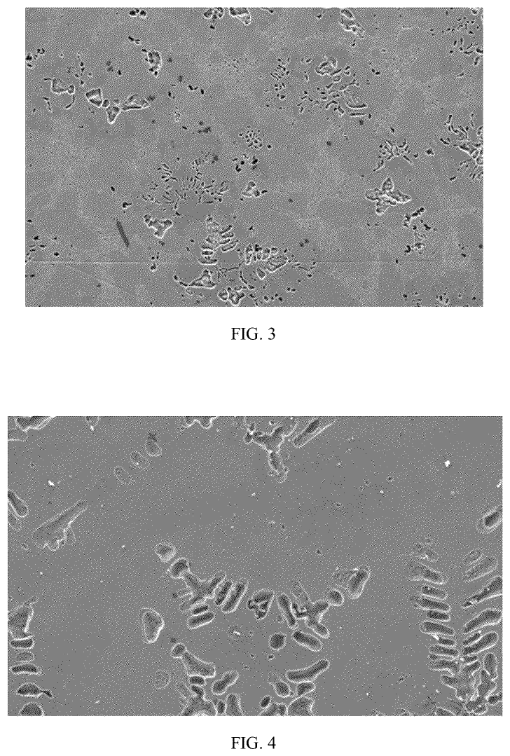

By comparing FIGS. 1-4, it can be seen that FIG. 1 shows decreased dendritic structures, increased inter-dendritic structures, as well as obviously reduced grain sizes. Hence, the effect of improving the hardness and wear resistance of the alloy is achieved.

By making a comparison in terms of hardness value, wear loss and hardness of the tempered alloy, it can be seen that the hardness reduction of NM500 after high-temperature tempering was 20%-30% higher than that of the Nb-element micro-alloyed multi-component alloy, and the multi-component alloy of the present invention shows better high-temperature stability.

The above description provides only preferred embodiments of the present invention, and is not intended to limit the present invention. Any modification, equivalent replacement, improvement or the like made according to the spirit and principle of the present invention shall be regarded as falling within the protection scope of the present invention.

What is claimed is:

1. A Nb-element micro-alloyed bulk multi-component alloy with a high-temperature resistance and a wear resistance, comprising chemical components, in weight percentages, of: 2.10-2.24 wt % of aluminum (Al), 20.70-20.86 wt % of chromium (Cr), 35.20-35.54 wt % of nickel (Ni), 19.10-19.46 wt % of titanium (Ti), 0.70-0.85 wt % of niobium (Nb), and a balance of iron (Fe) and unavoidable impurities, and the chemical components simultaneously meet the following three relations: (1) 24.76≤Fe/Nb≤31.72; (2) 6.81≤Fe/(Nb+Al)≤7.93; and (3) 1.04≤Fe/(Nb+Ti)≤1.13.

2. A preparation method for the Nb-element micro-alloyed bulk multi-component alloy with the high-temperature resistance and the wear resistance according to claim 1, comprising the following steps: proportioning according to the chemical components and the weight percentages of the Nb-element micro-alloyed bulk multi-component alloy with the high-temperature resistance and the wear resistance, smelting the chemical components with a vacuum arc smelting furnace to obtain a resulting mixture, and casting the resulting mixture with a copper mold process to obtain an ingot blank, wherein the ingot blank is a cast-molded material for a direct use, and the ingot blank is the Nb-element micro-alloyed bulk multi-component alloy with the high-temperature resistance and the wear resistance.

3. The preparation method for the Nb-element micro-alloyed bulk multi-component alloy with the high-temperature resistance and the wear resistance according to claim 2, wherein elemental particles of the Al, the Cr, the Fe, the Ni, the Ti, and the Nb with a purity of 99.99% are used as raw materials, and the raw materials are sanded on surfaces by sandpaper to remove surface oxides, sanded raw materials are ultrasonically cleaned in water and alcohol sequentially, and then cleaned raw materials are dried at a temperature of 50-80° C. for 0.5-2 h for a later use.

4. The preparation method for the Nb-element micro-alloyed bulk multi-component alloy with the high-temperature resistance and the wear resistance according to claim 2, wherein pretreated small metal particles are weighed according to usage amounts of respective elements for proportioning; and proportioned raw materials are placed and smelted by arranging high-melting-point elements below low-melting-point elements.

5. The preparation method for the Nb-element micro-alloyed bulk multi-component alloy with the high-temperature resistance and the wear resistance according to claim 2, wherein during a metal smelting, smelting parameters are set to the following values: a vacuum degree of 1.5-2.5×10⁻³ Pa, a pressure of −0.04 to −0.06 MPa after filling of an inert gas, and a smelting current of 250 A-700 A.

6. The preparation method for the Nb-element micro-alloyed bulk multi-component alloy with the high-temperature resistance and the wear resistance according to claim 2, wherein the step of smelting the chemical components with the vacuum arc smelting furnace and the step of casting the resulting mixture with the copper mold process are repeated for 1-3 times.

7. A method of using the Nb-element micro-alloyed bulk multi-component alloy with the high-temperature resistance and the wear resistance according to claim 1 in a preparation of a cutting tool or a mold with high wear resistance.

8. A method of using the Nb-element micro-alloyed bulk multi-component alloy with the high-temperature resistance and the wear resistance according to claim 1 in highly wear-resistant materials and a preparation of heat-resistant and wear-resistant materials for remanufacturing of mechanical products.

9. The preparation method for the Nb-element micro-alloyed bulk multi-component alloy with the high-temperature resistance and the wear resistance according to claim 3, wherein the step of smelting the chemical components with the vacuum arc smelting furnace and the step of casting the resulting mixture with the copper mold process are repeated for 1-3 times.

10. The preparation method for the Nb-element micro-alloyed bulk multi-component alloy with the high-temperature resistance and the wear resistance according to claim 4, wherein the step of smelting the chemical components with the vacuum arc smelting furnace and the step of casting the resulting mixture with the copper mold process are repeated for 1-3 times.

11. The preparation method for the Nb-element micro-alloyed bulk multi-component alloy with the high-temperature resistance and the wear resistance according to claim 5, wherein the step of smelting the chemical components with the vacuum arc smelting furnace and the step of casting the resulting mixture with the copper mold process are repeated for 1-3 times.
